(19) United States
(12) Patent Application Publication
(10) Pub. No.: US 2026/0171732 A1
(43) Pub. Date: Jun. 18, 2026

(54) Portable travel socket

(71) Applicant: Honglin Electric Power Technology (Thailand) Co., Ltd., Rayong (TH)

(72) Inventors: Shengchao HU, Rayong (TH); Xiongbing LIU, Rayong (TH); Li YU, Rayong (TH)

(73) Assignee: Honglin Electric Power Technology (Thailand) Co., Ltd., Rayong (TH)

(21) Appl. No.: 18/985,521

(22) Filed: Dec. 18, 2024

(51) Int. Cl. H01R 13/72; H01R 27/02

(52) U.S. Cl. CPC H01R 13/72; H01R 27/02

(57) ABSTRACT

A portable travel socket, comprising a shell and a back cover, wherein the shell is provided with jacks, the back cover and the shell are arranged in cooperation, the back cover is provided with a through hole, and a crank is rotationally installed at the through hole provided by the back cover, a power supply mechanism is fixedly installed in the shell, so that plugs can be inserted into the power supply mechanism through the jacks provided on the shell, and the power supply mechanism is used for power supply, a cable is fixedly connected to the power supply mechanism, a storage mechanism is rotationally installed in the shell and covers the power supply mechanism, the cable passes through the storage mechanism and is fixedly connected to the storage mechanism, and the crank is fixedly connected to the storage mechanism.

### TECHNICAL FIELD

The present invention relates to the technical field of travel equipment, and in particular to a portable travel socket.

### BACKGROUND TECHNOLOGY

Traditional sockets are commonly used in homes or offices, which are widely used and reliable, but not convenient to carry, especially when studying, traveling or travelling. On the one hand, users may only need to add one or two sockets, and on the other hand, they also want to charge their mobile phones or tablets through the sockets, but do not want a long power cord to affect portability. Therefore, a travel portable socket is needed to solve the above problems.

### SUMMARY OF THE INVENTION

The purpose of the embodiment of the present invention is to provide a portable travel socket, which can accommodate a long power cord, provide more power sockets and USB sockets, and is very easy to carry when used.

Embodiments of the present invention are implemented as follows: a portable travel socket, comprises a shell and a back cover, wherein the shell is provided with jacks, the back cover and the shell are arranged in cooperation, the back cover is provided with a through hole, and a crank handle is rotationally installed at the through hole provided by the back cover; a power supply mechanism is fixedly installed in the shell, plugs are inserted into the power supply mechanism through the jacks provided on the shell, the power supply mechanism is used for power supply, and a cable is fixedly connected to the power supply mechanism; and a storage mechanism is rotationally installed in the shell and covers the power supply mechanism, the cable passes through the storage mechanism and is fixedly connected to the storage mechanism, and the crank handle is fixedly connected to the storage mechanism.

Preferably, the storage mechanism comprises: a fixed slot fixedly installed in the shell and arranged in the storage mechanism, wherein a contact pin is installed in the fixed slot, and a cable is connected to the contact pin to supply power to the contact pin; a plug-in block fixed in the shell and arranged on both sides of the fixed slot, wherein the cable is connected to the plug-in block, and a USB device could be inserted into the plug-in block for power supply.

Preferably, the storage mechanism comprises: a rotating sleeve rotationally installed in the shell and covers the power supply mechanism, wherein the cable passes through the rotating sleeve and is fixedly connected to the rotating sleeve, and the rotating sleeve is provided with a slot; and a clamping block arranged in cooperation with the slot provided by the rotating sleeve, wherein the clamping block can be inserted into the slot, the crank handle is fixedly connected to the clamping block, and the crank handle can drive the rotating sleeve to rotate through the clamping block to store the cable.

The portable travel socket provided by the present invention mainly solves the pain points that traditional sockets are large in size and wires are inconvenient to carry and store. It can not only ensure that the functions of the plug and socket meet the needs, but also allow the wires to be stored by rotation when not in use. The rear cover can be opened during storage, which is convenient for collecting and organizing the wires.

### BRIEF DESCRIPTION OF THE DRAWINGS

FIG. 1 is a schematic diagram of a portable travel socket.

FIG. 2 is a schematic diagram of the back of a portable travel socket.

FIG. 3 is a cross-sectional view of the back of a portable travel socket.

FIG. 4 is a schematic diagram of the power supply mechanism of the portable travel socket.

The markups in the drawings are indicated as follows:
1—shell;
2—back cover;
3—crank handle;
4—power supply mechanism;
5—cable;
6—storage mechanism;
41—fixed slot;
42—contact pin;
43—plug-in block;
61—rotating sleeve; and
62—clamping block.

### SPECIFIC EMBODIMENTS

In order to make the purpose, technical solutions and advantages of the present invention more clearly understood, the present invention is further described in detail below in conjunction with the accompanying drawings and embodiments. It should be understood that specific embodiments described herein are only used to explain the present invention and do not limit the present invention.

The specific implementation of the present invention is described in detail below in conjunction with the specific embodiments.

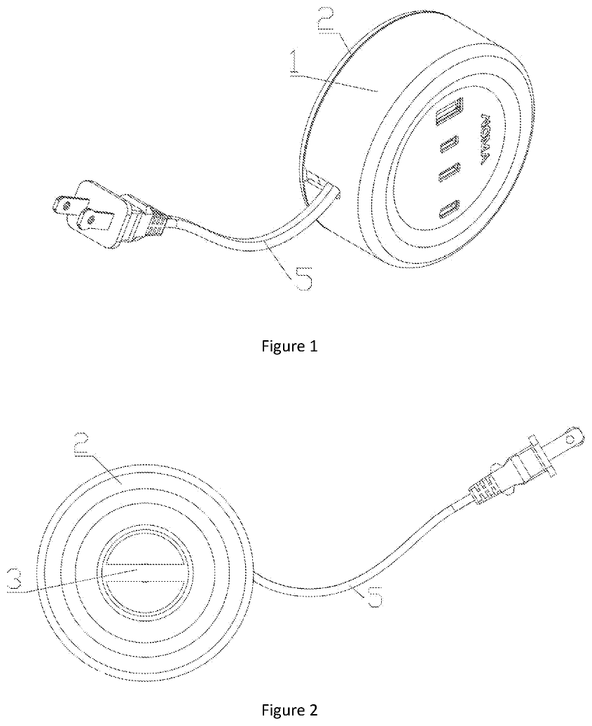

Please refer to FIGS. 1-4, an embodiment of the present invention provides a portable travel socket, comprising:
a shell 1 and a back cover 2, wherein the shell is provided with jacks, the back cover 2 and the shell 1 are arranged in cooperation, the back cover 2 is provided with a through hole, and a crank handle 3 is rotationally installed at the through hole provided by the back cover 2; a power supply mechanism 4 is fixedly installed in the shell 1, plugs are inserted into the power supply mechanism 4 through the jacks provided on the shell 1, the power supply mechanism 4 is used for power supply, and a cable 5 is fixedly connected to the power supply mechanism 4; and a storage mechanism 6 is rotationally installed in the shell 1 and covers the power supply mechanism 4, the cable 5 passes through the storage mechanism 6 and is fixedly connected to the storage mechanism 6, and the crank handle 3 is fixedly connected to the storage mechanism 6, so that the crank handle 3 can drive the storage mechanism 6 to rotate to store the cable 5.

When the portable travel socket is used, the cable 5 can be first inserted into an external socket, and the cable 5 can supply power to the power supply mechanism 4, an electrical device can be inserted into the power supply mechanism 4 through the socket provided in the shell 1, so as to supply power to the electrical device. When it needs to store the cable 5, the crank handle 3 on the back cover 2 is rotated, and the crank handle 3 drives the storage mechanism 6 to rotate, so that the cable 5 can be stored, and the back cover 2 can be opened, so that the cable 5 can be conveniently organized.

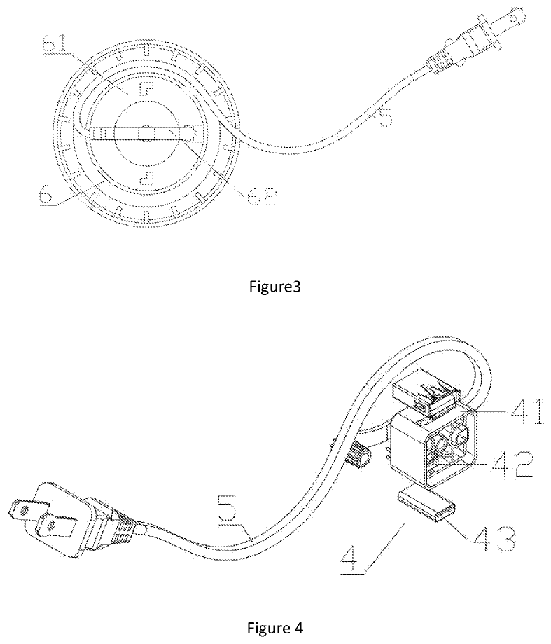

As shown in FIG. 4, in a preferable embodiment of the present invention, the storage mechanism 4 comprises:
a fixed slot 41 fixedly installed in the shell 1 and arranged in the storage mechanism 6, wherein a contact pin 42 is installed in the fixed slot 41, and a cable 5 is connected to the contact pin 42 to supply power to the contact pin 42;
a plug-in block 43 fixed in the shell 1 and arranged on both sides of the fixed slot 41, wherein the cable 5 is connected to the plug-in block 43, and a USB device could be inserted into the plug-in block 43 for power supply.

After the cable 5 is connected to an external socket, the cable 5 can supply power to contact pin 42 and the plug-in block 43. The electrical device can be supplied to the electrical device by inserting the electrical device into the contact pin 42 or the plug-in block 43 through jacks provided in the shell 1.

As shown in FIG. 3, in a preferable embodiment of the present invention, the storage mechanism 6 comprises:
a rotating sleeve 61 rotationally installed in the shell 1 and covers the power supply mechanism 4, wherein the cable 5 passes through the rotating sleeve 61 and is fixedly connected to the rotating sleeve 61, and the rotating sleeve 61 is provided with a slot;
a clamping block 62 arranged in cooperation with the slot provided by the rotating sleeve 61, wherein the clamping block 62 can be inserted into the slot, the crank handle 3 is fixedly connected to the clamping block 62, and the crank handle 3 can drive the rotating sleeve 61 to rotate through the clamping block 62 to store the cable 5.

When it needs to store the cable 5, the crank handle 3 is turned, so that the crank handle 3 drives the rotating sleeve 61 to rotate through the clamping block 62, and the rotating sleeve 61 can be rotated to store the cable 5.

The above descriptions are only some preferred embodiments of the present invention and are not intended to limit the present invention. Any modifications, equivalent substitutions and improvements made within the spirit and principles of the present invention should be included in the protection scope of the present invention.

1. A portable travel socket, comprising a shell and a back cover, wherein the shell is provided with jacks, the back cover and the shell are arranged in cooperation, the back cover is provided with a through hole, and a crank handle is rotationally installed at the through hole provided by the back cover;
a power supply mechanism is fixedly installed in the shell, plugs are inserted into the power supply mechanism through the jacks provided on the shell, the power supply mechanism is used for power supply, and a cable is fixedly connected to the power supply mechanism; and
a storage mechanism is rotationally installed in the shell and covers the power supply mechanism, the cable passes through the storage mechanism and is fixedly connected to the storage mechanism, and the crank handle is fixedly connected to the storage mechanism.

2. The portable travel socket according to claim 1, wherein the storage mechanism comprises:
a fixed slot fixedly installed in the shell and arranged in the storage mechanism, wherein a contact pin is installed in the fixed slot, and a cable is connected to the contact pin to supply power to the contact pin;
a plug-in block fixed in the shell and arranged on both sides of the fixed slot, wherein the cable is connected to the plug-in block, and a USB device could be inserted into the plug-in block for power supply.

3. The portable travel socket according to claim 1, wherein the storage mechanism comprises:
a rotating sleeve rotationally installed in the shell and covers the power supply mechanism, wherein the cable passes through the rotating sleeve and is fixedly connected to the rotating sleeve, and the rotating sleeve is provided with a slot;
a clamping block arranged in cooperation with the slot provided by the rotating sleeve, wherein the clamping block can be inserted into the slot, the crank handle is fixedly connected to the clamping block, and the crank handle can drive the rotating sleeve to rotate through the clamping block to store the cable.
